(19) United States
(12) Patent Application Publication
(10) Pub. No.: US 2017/0192616 A1
(43) Pub. Date: Jul. 6, 2017

(54) TOUCH SCREEN DEVICE AND DISPLAY DEVICE USING THREE-DIMENSIONAL POSITION INFORMATION

(71) Applicant: RNDPLUS CO., LTD., GOYANG (KR)

(72) Inventor: YONG-CHUL KIM, GOYANG (KR)

(73) Assignee: RNDPLUS CO.,LTD, GOYANG (KR)

(21) Appl. No.: 15/325,874

(22) PCT Filed: Jul. 21, 2015
(86) PCT No.: PCT/KR2015/007517

§ 371 Date: Jan. 12, 2017

(30) Foreign Application Priority Data
Jul. 21, 2014 (KR) 10-2014-0091840

(51) Int. Cl. G06F 3/042; G06F 3/041

(52) U.S. Cl. CPC G06F 3/0421; G06F 3/0416; G06F 2203/04101

(57) ABSTRACT

The touch screen apparatus according to the invention includes: a first frame having a plurality of optical transmission units arranged in a row along a first direction and stacked in a third direction orthogonal to the first direction; a second frame facing the first frame and having a plurality of optical reception units arranged in a row along the first direction and stacked in the third direction; and a control unit connected to the first frame and the second frame for controlling the plurality of optical transmission units and the plurality of optical reception units to be operated, and detecting a touch position in a three-dimensional space by using a signal detected at the plurality of optical reception units.

### TECHNICAL FIELD

The present invention relates to a touch screen apparatus and a display apparatus, and more particularly, to a touch screen apparatus and a display apparatus using three-dimensional (3D) position information.

### BACKGROUND ART

In general, a touch screen apparatus is an apparatus for providing an interface between a user and a display device for outputting image information, such as a plasma display panel (PDP), a liquid crystal display (LCD), or a flat panel display (FPD) having another form.

The touch screen apparatus has been widely commercialized in an automated teller machine (ATM) of a bank, a portable multimedia player (PMP) and so on.

The touch screen apparatus is classified into a piezoelectric film type and an infrared type. The piezoelectric film type is mainly used for a small display unit, and the infrared type is mainly used for a large display unit.

The infrared type touch screen apparatus includes a rectangular frame arranged at a circumference of a display unit of the display device. The frame includes an infrared transmission unit for transmitting infrared rays and an infrared reception unit for receiving infrared rays, and includes a control unit for controlling operations of the infrared transmission unit and the infrared reception unit and detecting a touch according to a signal detected at the infrared reception unit.

However, a conventional touch screen apparatus detects only a two-dimensional touch because the infrared transmission unit and the infrared reception unit are two-dimensionally arranged on the same plane.

On the other hand, though a technique for detecting a three-dimensional touch has been disclosed in Korea Patent No. 10-1100369, the manufacturing process is complicated and the manufacturing cost is expensive because this technique adopts touch light and ultrasonic waves.

### DISCLOSURE

### Technical Problem

An object of the present invention is to provide a touch screen apparatus and a display apparatus having novel structures.

In addition, an object of the present invention is to provide a touch screen apparatus and a display apparatus for detecting a three-dimensional touch.

Further, an object of the present invention is to provide a touch screen apparatus and a display apparatus for more accurately detecting a touch position.

### Technical Solution

The touch screen apparatus according to the invention includes: a first frame having a plurality of optical transmission units arranged in a row along a first direction and stacked in a third direction orthogonal to the first direction; a second frame facing the first frame, and having a plurality of optical reception units arranged in a row along the first direction and stacked in the third direction; and a control unit connected to the first frame and the second frame for controlling an operation of the plurality of optical transmission units and the plurality of optical reception units, and detecting a touch position in a three-dimensional space by using a signal detected at the plurality of optical reception units.

The display apparatus according to the invention includes: a display unit for displaying an image; and a touch screen apparatus using three-dimensional position information, in which the touch screen apparatus includes a first frame arranged adjacent to the display unit, and having a plurality of optical transmission units arranged in a row along the first direction and stacked in the third direction orthogonal to the first direction, a second frame facing the first frame, and having a plurality of optical reception units arranged in a row along the first direction and stacked in the third direction, and a control unit connected to the first frame and the second frame for controlling an operation of the plurality of optical transmission units and the plurality of optical reception units and detecting a touch position in the three-dimensional space by using a signal detected at the plurality of optical reception units.

### Advantageous Effects

The present invention can provide a touch screen apparatus and a display apparatus having novel structures.

In addition, the present invention can provide a touch screen apparatus and a display apparatus, for detecting a three-dimensional touch.

Further, the present invention can provide a touch screen apparatus and a display apparatus, for more accurately detecting a touch position.

### DESCRIPTION OF DRAWINGS

FIG. 1 to FIG. 13 are views for explaining a touch screen apparatus and a display apparatus according to a first embodiment.

FIG. 14 to FIG. 20 are views for explaining a touch screen apparatus and a display apparatus according to a second embodiment.

FIG. 21 is a view for explaining detection of changes of user actions according to the embodiment of the present invention.

FIG. 22 is a view for explaining a touch screen apparatus and a display apparatus according to the second embodiment.

### BEST MODE

### Mode for Invention

Hereinafter, a touch screen apparatus and a display apparatus according to embodiments of the present invention will be described in detail with reference to the accompanying drawings.

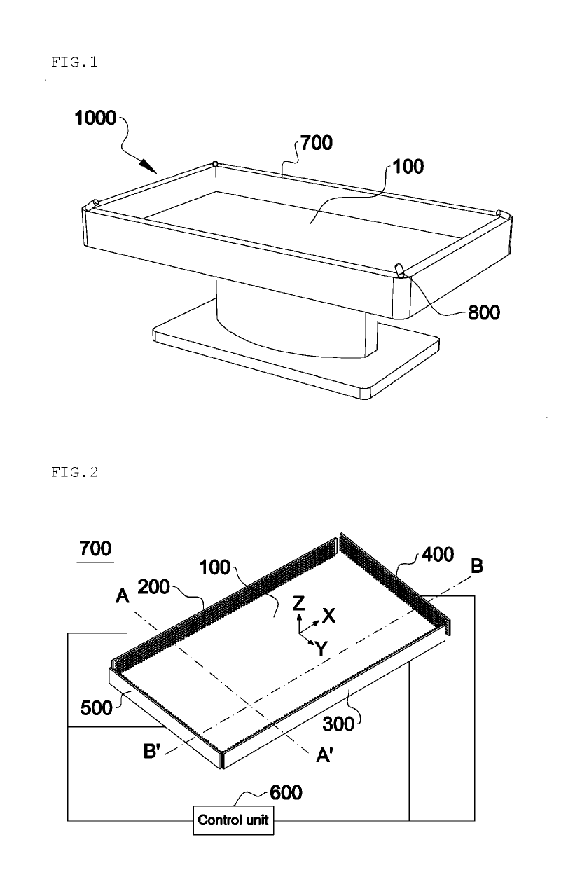

FIG. 1 to FIG. 13 are views for explaining a touch screen apparatus and a display apparatus according to a first embodiment.

FIG. 1 is a view for explaining a touch screen apparatus and a display apparatus according to the embodiment, and FIG. 2 is a view for explaining a frame of the touch screen apparatus and the display apparatus according to the embodiment.

Referring to FIG. 1 and FIG. 2, the display apparatus 1000 includes a display unit 100 and a touch screen apparatus 700 arranged at one side of the display unit 100. The touch screen apparatus 700 includes a plurality of frames 200, 300, 400, and 500 including an infrared transmission unit and an infrared reception unit, and a control unit 600 for controlling the infrared transmission unit and the infrared reception unit and detecting a touch by using a signal from the infrared reception unit.

The control unit 600 may detect X-axis, Y-axis, and Z-axis coordinates of a position touched by a user. In the embodiment, a plane parallel to a surface of the display unit 100 is represented as an X-Y plane, a direction parallel to a long side of the display unit 100 is represented as an X-axis direction, a direction parallel to a short side of the display unit 100 is represented as a Y-axis direction, and a direction perpendicular to the X-Y plane is represented as a Z-axis direction,

In addition, the display apparatus 1000 may further include an image detecting unit 800. The image detecting unit 800 will be described hereinafter.

Although not shown in FIG. 2, the control unit 600 is connected to the image detecting unit 800 for controlling the image detecting unit and detecting a touch according to a signal from the image detecting unit 800.

The plurality of frames 200, 300, 400, and 500 include a first frame 200, a second frame 300, a third frame 400, and a fourth frame 500.

For example, the first frame 200 and the second frame 300 may be arranged at the long sides of the display unit 100, and the third frame 400 and the fourth frame 500 may be arranged at the short sides of the display unit 100.

Further, for example, the first frame 200 and the second frame 300 also may be arranged at the short sides of the display unit 100, and the third frame 400 and the fourth frame 500 may be arranged at the long sides of the display unit 100. However, the embodiment illustrates the first frame 200 and the second frame 300 arranged at the long sides of the display unit 100.

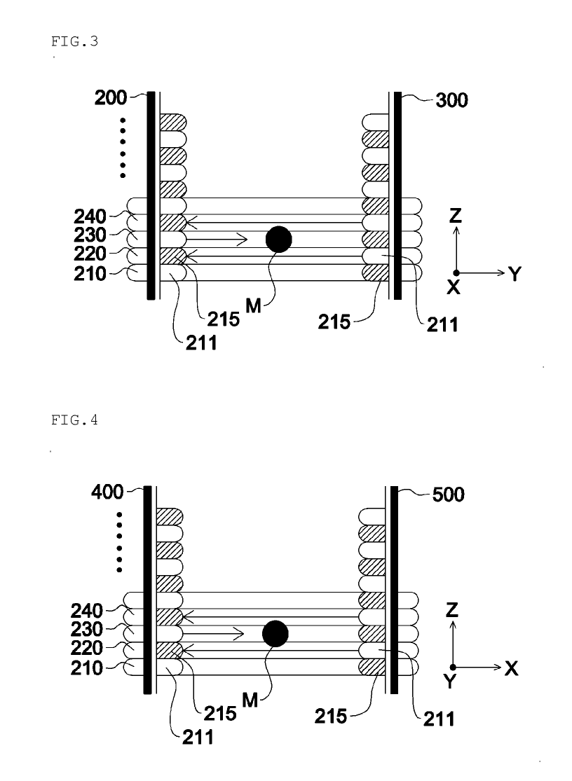

FIG. 3 is a view showing a cross section taken along line A-A′ of FIG. 2, and FIG. 4 is a view showing a cross section taken along line B-B′ of FIG. 2.

Referring to FIG. 3 and FIG. 4, an infrared transmission unit 211 serving as a light emitting element and an infrared reception unit 215 serving as a light receiving element are alternately stacked on the first frame 200 in the Z-axis direction, in which the infrared transmission unit 211 and the infrared reception unit 215 extend in a row in the X-axis direction, respectively. Although the infrared transmission unit 211 for emitting infrared rays is represented as an example of the light emitting element and the infrared reception unit 215 for receiving infrared rays is represented, a type of light may be changed, so the infrared transmission unit 211 may be an exemplary embodiment of an optical transmission unit and the infrared reception unit 215 may be an exemplary embodiment of an optical reception unit.

The infrared reception unit 215 and the infrared transmission unit 211 are alternately stacked on a second frame 300, which faces the first frame 200, in the Z-axis direction, and the infrared reception unit 215 and the infrared transmission unit 211 separately extend in a row in the X-axis direction.

The infrared transmission unit 211 arranged in the X-axis direction on the first frame 200 and the infrared reception unit 215 arranged in the X-axis direction on the second frame 300 are spaced apart from the display unit 100 by a first gap in the Z-axis direction, thereby forming a first touch detection layer 210 which is a plane parallel to the surface of the display unit 100.

In addition, the infrared reception unit 215 on the first frame 200 and the infrared transmission unit 211 on the second frame 300 are spaced apart from the display unit 100 by a second gap in the Z-axis direction, thereby forming a second touch detection layer 220 which is a plane parallel to the surface of the display unit 100.

In this manner, the first frame 200 and the second frame 300 may be provided thereon with a third touch detection layer 230, a fourth touch detection layer 240, and nth touch detection layer where the infrared transmission unit 211 and the infrared reception unit 215 are alternately stacked in the Z-axis direction.

Similarly to the first frame 200 and the second frame 300, the infrared reception unit 215 and the infrared transmission unit 211 are alternately stacked on the third frame 400 and the fourth frame 500 in the Z-axis direction, and separately extend in a row in the Y-axis direction.

The infrared transmission unit 211 arranged in the Y-axis direction on the third frame 400 and the infrared reception unit 215 arranged in the Y-axis direction on the fourth frame 500 are spaced apart from the display unit 100 by the first gap in the Z-axis direction, thereby forming the first touch detection layer 210 which is a plane parallel to the surface of the display unit 100.

In addition, the infrared reception unit 215 on the third frame 400 and the infrared transmission unit 211 on the fourth frame 500 are spaced apart from the display unit 100 by the second gap in the Z-axis direction, thereby forming the second touch detection layer 220 which is a plane parallel to the surface of the display unit 100.

In this manner, the third frame 400 and the fourth frame 500 may include the third touch detection layer 230, fourth touch detection layer 240, and nth touch detection layer where the infrared transmission unit 211 and the infrared reception unit 215 are alternately stacked in the Z-axis direction.

In another embodiment, the first frame 200 and the third frame 400 may be manufactured to include only the infrared transmission unit 211 without the infrared reception unit 215, and the second frame 300 and the fourth frame 500 may be manufactured to include only the infrared reception unit 215 without the infrared transmission unit 211.

Various modified embodiments may be realized when the infrared transmission unit 211 and the infrared reception unit 215 are provided on one touch detection layer while facing each other as described above.

The X-axis, Y-axis, and Z-axis coordinates of the position touched by the user may be detected when at least one infrared transmission unit 211 and at least one infrared reception unit 215 constitute a plurality of touch detection layers.

In the embodiment of the present invention, the X-axis, Y-axis, and Z-axis coordinates of the position touched by the user may be detected by using the first frame 200, the second frame 300, the third frame 400, and fourth frame 500.

In addition, the X-axis, Y-axis, and Z-axis coordinates of the position touched by the user may be detected just by using the first frame 200 and the second frame 300, and the X-axis, Y-axis, and Z-axis coordinates of the position touched by the user may be detected just by using the third frame 400 and fourth frame 500.

For example, in order to detect a touch object M, a scanning is performed at a lowest touch detection layer to detect X-axis and Y-axis coordinates, and the scanning is performed in the direction away from the display unit 100 along the Z-axis direction. The scanning may be repeated several times.

In addition, in order to reversely detect the touch object M, the scanning is performed at an uppermost touch detection layer to detect the X-axis and Y-axis coordinates, and the scanning is performed toward the display unit 100 in the Z-axis direction. The scanning may be repeated several times.

Subsequently, when the touch object M is detected in the middle of performing the scanning while changing the touch detection layer in the Z-axis direction, the corresponding touch detection layer serves as a Z-axis coordinate of the touch object M.

In addition, the Z-axis coordinate of the touch object M may be detect in advance, and then, the X-axis coordinate and the Y-axis coordinate are detected by using schemes such as a rectangular scan or an oblique-angle scan at a touch detection layer corresponding to the Z-axis coordinate.

In addition, for example, a scanning for detecting two-dimensional X-axis and Y-axis coordinates is performed from a first touch detection layer 210 which is the lowest touch detection layer through the first frame 200 and the second frame 300, and then a scanning for detecting two-dimensional X-axis and Y-axis coordinates is performed at a second touch detection layer 220 in the Z-axis direction. Subsequently, the height corresponding to a third touch detection layer 230 in the Z-axis direction serves as a Z-axis coordinate of the touch object M, when the touch object M is detected at the third touch detection layer 230 in the Z-axis direction during the scanning for detecting two-dimensional X-axis and the Y-axis coordinates.

Then, the X-axis and Y-axis coordinates, which are two-dimensional X-axis and Y-axis coordinates of the touch object M of which the Z-axis coordinate is detected at the third touch detection layer 230, are detected by the rectangular scan and the oblique-angle scan, thus X-axis, Y-axis, and Z-axis coordinates of the touch object M may be finally detected.

In addition, when a scanning for detecting two-dimensional coordinates is performed through the first frame 200 and the second frame 300, and then a scanning for detecting the two-dimensional coordinates is performed through the third frame 400 and the fourth frame 500, the X-axis and Y-axis coordinates of the touch object M may be detected more accurately.

Further, the first embodiment of the present invention may further include the image detecting unit 800 provided at an upper edge of the touch screen apparatus 700, having a camera to detect changes of images obtained by the camera, and arranged to be oriented to the slanting direction over the display unit 100.

A plurality of the image detecting units 800 may be arranged, and a cross point of extension lines from the image detecting units 800 may become the center of the display unit 100.

According to the present invention, a motion of the touch object M deviated from a space between the first frame 200, the second frame 300, the third frame 400, and the fourth frame 500 may be detected by providing the image detecting unit 800.

In other words, the image detecting unit 800 may supplement or assist the detection of the motion of the touch object M by detecting a motion image through the camera.

For example, coordinates of a finger of the user are detected when the finger is positioned within the space between the first to fourth frames 200, 300, 400, and 500, however, the coordinates of the finger are impossible to be detected when the finger deviates from the space between the first to fourth frames 200, 300, 400, and 500, thus the motion of the finger of the user in the Z-axis direction may be detected by using the image detecting unit 800.

On the other hand, various manners to detect an X-axis coordinate and a Y-axis coordinate in one planar space through the first frame 200, the second frame 300, the third frame 400, and fourth frame 500 will be described hereinafter.

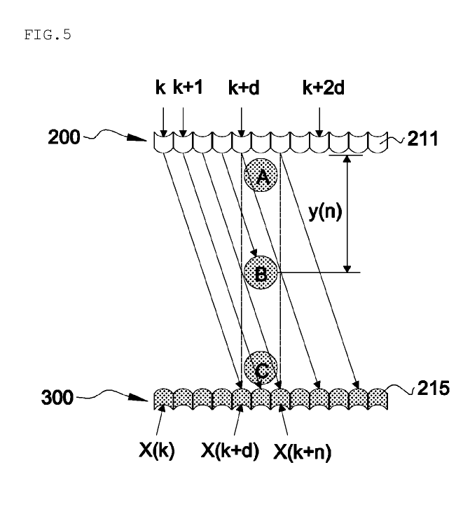

FIG. 5 to FIG. 13 are views showing a technique for detecting coordinates of the touch object M. The technique is described in detail in Korean patent registration No. 10-1076871, Korean patent registration No. 10-1372423, Korean patent registration No. 10-1057620, Korean patent registration No. 10-1260341, Korean patent registration No. 10-1323196, Korean patent registration No. 10-1076871, and so on filed by Rndplus Co., Ltd., and is incorporated by reference in the present patent application. The technique for detecting coordinates will be briefly described hereinafter.

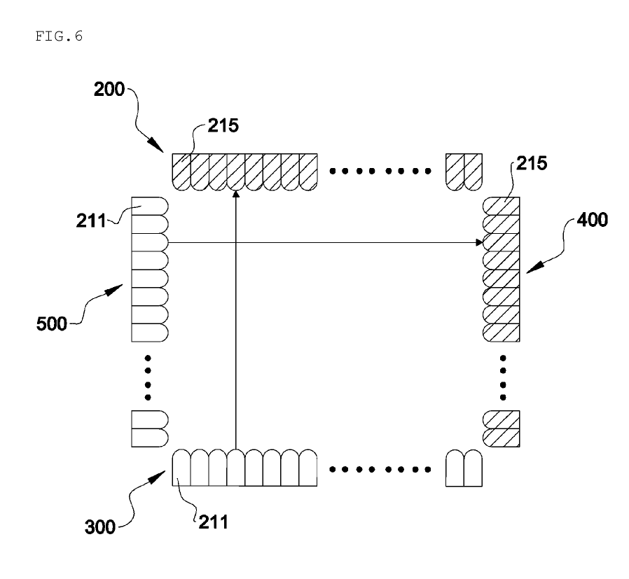

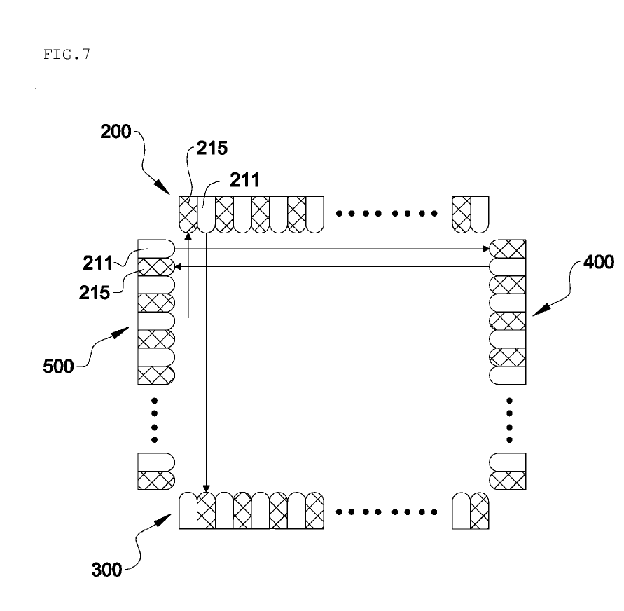

FIG. 5 and FIG. 6 are views showing one embodiment of techniques for detecting an X-axis coordinate and a Y-axis coordinate according to the present invention.

Referring to FIG. 5 and FIG. 6, the X-axis coordinate and the Y-axis coordinate may be detected by using the first frame 200 and the second frame 300 or using the third frame 400 and fourth frame 500.

According to an exemplary embodiment, FIG. 5 illustrates the infrared transmission unit 211 provided at the first frame 200 and the infrared reception unit 215 provided at the second frame 300.

According to a modified embodiment of the present invention, the infrared transmission unit 211 may be provided at the second frame 300, and the infrared reception unit 215 may be provided at the first frame 200. In addition, the infrared transmission unit 211 may be provided on at least one of the third frame 400 and the fourth frame 500, and the infrared reception unit 215 may be provided on the opposite frame.

The infrared transmission unit 211 may be arranged on the first frame 200 in such a state of k, k+1, k+d and k+2d along the X-axis direction, and the infrared reception unit 215 may be arranged on the second frame 300 in an order of X(k), X(k+d), . . . , and X(k+n) along the X-axis direction, in which “d” denotes a position of the infrared transmission unit 211 facing the infrared reception unit 215 positioned at an oblique angular place reached by infrared rays transmitted from a kth infrared transmission unit 211, and serves as a factor for determining an oblique angle representing a slope of the infrared rays transmitted from the infrared transmission unit 211.

A, B, and C illustrated in FIG. 5 are examples of a touch region on the display unit 100, the user may select and touch one of the A, B, and C, or may multi-touch simultaneously.

A touch object arranged at the touch region blocks a touch measuring signal. In other words, the touch object blocks the touch measuring signal which is outputted from the infrared transmission unit 211 and inputted into the infrared reception unit 215.

For example, infrared reception units 215, which are arranged at various positions such as acute angular, rectangular, and obtuse angular positions with respect to the infrared transmission unit 211, are sequentially operated while performing a scanning, when a specific infrared transmission unit 211 transmits the touch measuring signal, and the infrared reception unit 215 receives the touch measuring signal while operating infrared transmission units 211 arranged at various positions, thus the control unit 600 may detect an X-axis coordinate of the touch object.

A procedure for detecting a Y-axis coordinate such as y(n) is the same with the procedure for detecting the X-axis coordinate. The infrared transmission unit 211 and the infrared reception unit 215 are sequentially operated, and a position where the touch measuring signal does not received because of being blocked is detected, thus the Y-axis coordinate may be detected.

For reference, a virtual image may be generated upon multi-touch, however the virtual image may not be generated according to the present invention.

The virtual image may be generated because the infrared transmission unit 211 and the infrared reception unit 215, which are arranged on the X-axis and Y-axis, scan in a matrix type. For example, when two points of the touch region are touched in the case of scanning in the matrix type, a virtual image recognized as a touch point may be generated even though the points, where lines extending from the two points in the X-axis direction and the Y-axis direction intersect with each other, are not actual touch points.

According to the present invention, however, the scanning is not performed in the matrix type, but performed in various directions such as an acute angle, a rectangle, and an obtuse angle, thereby preventing the virtual image.

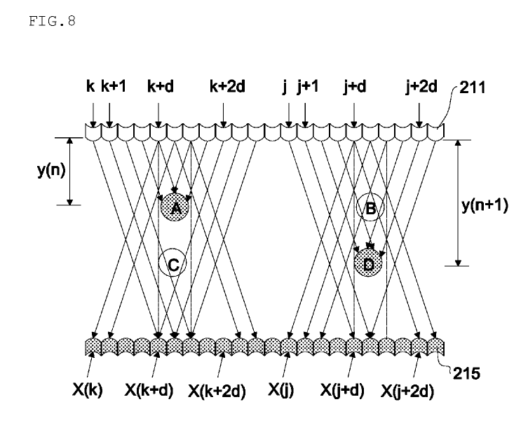

FIG. 7 is a view explaining another embodiment of techniques for detecting an X-axis coordinate and a Y-axis coordinate according to the present invention.

As shown in FIG. 7, the infrared transmission unit 211 and the infrared reception unit 215 may be arranged to be mixed on the first frame 200, the second frame 300, the third frame 400, and the fourth frame 500, or the infrared transmission unit 211 and the infrared reception unit 215 may be alternately arranged.

Accordingly, when the infrared transmission unit 211 and the infrared reception unit 215 are arranged to be mixed and alternated on the first frame 200, the second frame 300, the third frame 400, and the fourth frame 500, respectively, the speed for scanning the touch object may be improved twice, and the touch object may be detected in a reverse direction in the case of being difficult to detect the touch object in a specific direction due to natural light such as sun light.

FIG. 8 to FIG. 11 are views explaining another embodiment of techniques for detecting an X-axis coordinate and a Y-axis coordinate according to the present invention.

FIG. 8 shows the infrared reception unit 215 scans a touch measuring signal transmitted from the infrared transmission unit 211 in a rectangular direction, and then sequentially scans in an acute angular or an obtuse angular direction.

In other words, the infrared reception unit 215 may scan in the acute angular direction after scanning in the rectangular direction, or scan in the obtuse angular direction after scanning in the rectangular direction.

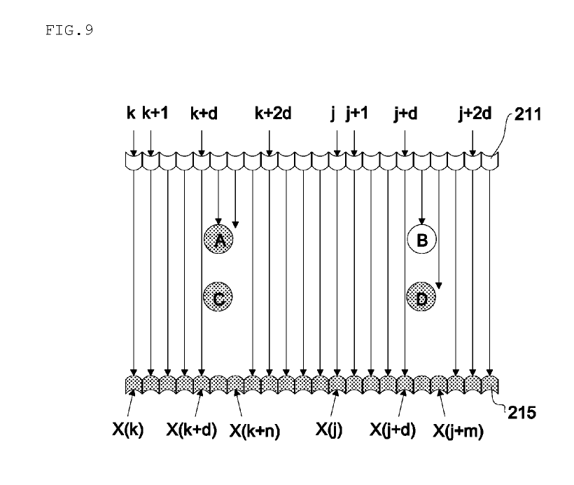

As shown in FIG. 9, the infrared reception unit 215 obtains an X-axis coordinate by scanning a touch measuring signal transmitted from the infrared transmission unit 211 in a rectangular direction, and likewise, though not shown in the drawings, measures a Y-axis coordinate by scanning the touch measuring signal in the rectangular direction.

If the touch object is positioned at A, C, and D, it is regarded that the touch object is arranged at a position B. In other words, B is a virtual image. In other words, two touch positions on the X-axis and two touch positions on the Y-axis are detected, thus four touch positions including the virtual image are finally detected.

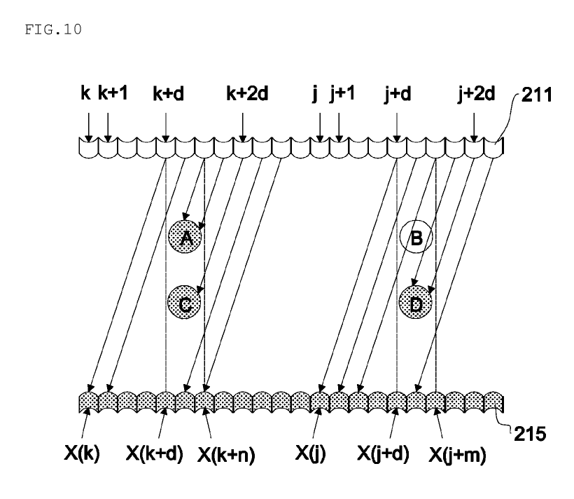

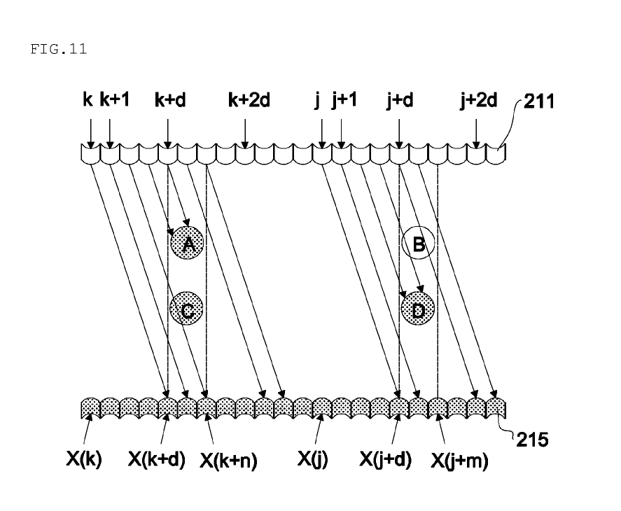

Therefore, because a scanning in the rectangular direction may include a virtual image, the scanning is performed in the acute angular direction or the obtuse angular direction, as shown in FIG. 10 and FIG. 11, so that a touch position without a virtual image may be detected.

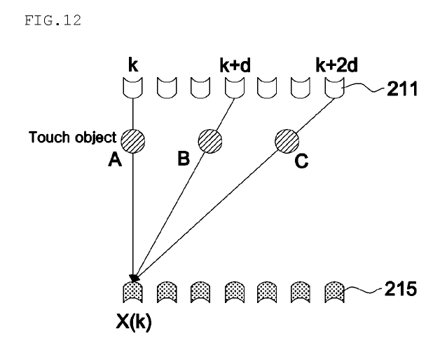

FIG. 12 is a view explaining another embodiment of techniques for detecting an X-axis coordinate and a Y-axis coordinate according to the present invention.

Referring to FIG. 12, one infrared reception unit 215 detects touch measuring signals sequentially irradiated from a plurality of infrared transmission units 211, in which the one infrared reception unit 215 may detect the touch measuring signals in acute angular, rectangular, and obtuse angular directions.

Accordingly, in the case that the touch object is positioned at the position A, B, and C, the infrared reception unit 215 is not able to detect touch measuring signals when infrared transmission units 211 positioned at k, k+d, and k+2d irradiate the touch measuring signals, thereby detecting the touch object upon the multi-touch.

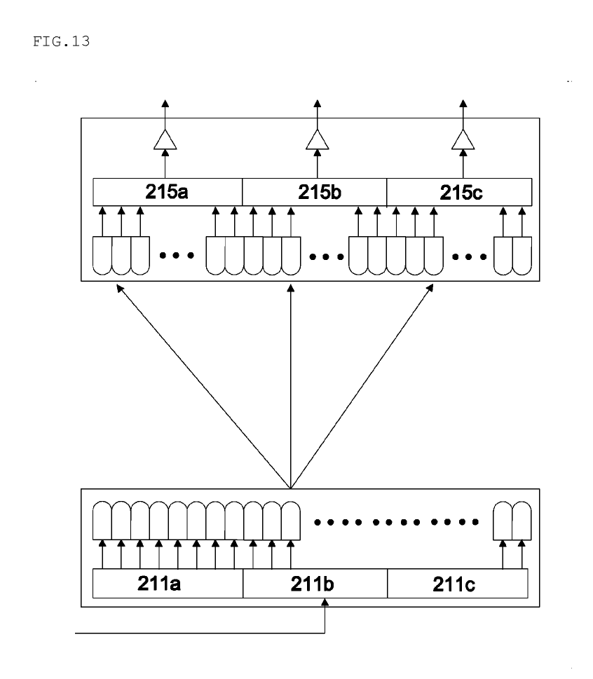

FIG. 13 is a view explaining another embodiment of techniques for detecting an X-axis coordinate and a Y-axis coordinate according to the present invention.

Referring to FIG. 13, an infrared transmission group 211a, 211b, and 211c and an infrared reception group 215a, 215b, and 215c may be provided. The infrared transmission group 211a, 211b, and 211c and the infrared reception group 215a, 215b, and 215c may include a plurality of infrared transmission units and infrared reception units, respectively, and may detect a position of the touch object by detecting touch measuring signals detected from each of the infrared reception group 215a, 215b, and 215c.

In other words, in FIG. 13, a plurality of infrared transmission units are simultaneously operated, and a plurality of infrared reception units simultaneously detect the touch measuring signals.

As described above, it is possible to measure the two-dimensional X-axis and Y-axis coordinates by using various manners.

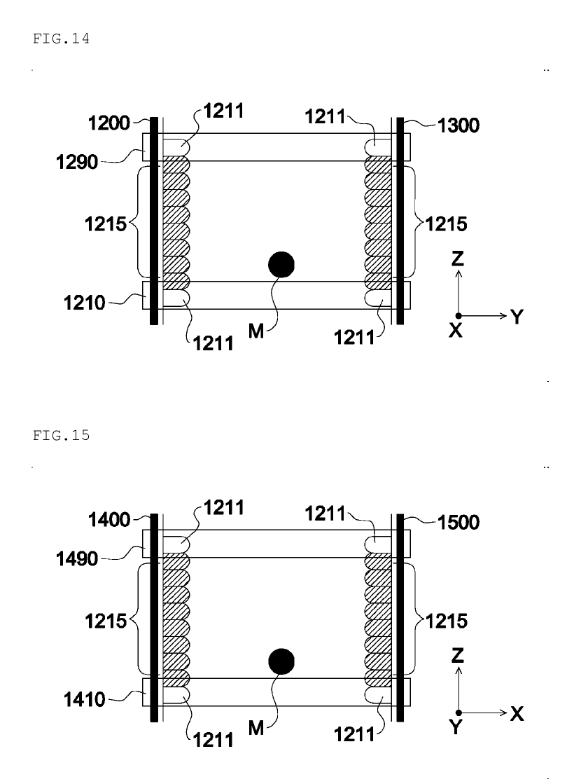

FIG. 14 to FIG. 20 are views for explaining the touch screen apparatus and the display apparatus according to a second embodiment.

FIG. 14 is a view according to the second embodiment, showing a cross section taken along the line A-A′ of FIG. 2, and FIG. 15 is a view according to the second embodiment, showing a cross section taken along the line B-B′ of FIG. 2.

Referring to FIG. 14 and FIG. 15, infrared transmission units 1211 are provided at a lowest end part 1210 and an uppermost end part 1290 of a first frame 1200 and arranged in a row in the X-axis direction, and a plurality of infrared reception units 1215 are provided between the lowest end part 1210 and the uppermost end part 1290 in the Z-axis direction and arranged in a row in the X-axis direction.

In addition, infrared transmission units 1211 are provided at a lowest end part 1210 and an uppermost end part 1290 of a second frame 1300 corresponding to the first frame 1200 and arranged in a row in the X-axis direction, and a plurality of infrared reception units 1215 are provided between the lowest end part 1210 and the uppermost end part 1290 in the Z-axis direction and arranged in a row in the X-axis direction.

Likewise, infrared transmission units 1211 are provided at a lowest end part 1410 and an uppermost end part 1490 of a third frame 1400 and arranged in a row in the Y-axis direction, and a plurality of infrared reception units 1215 are provided between the lowest end part 1410 and the uppermost end part 1490 in the Z-axis direction and arranged in a row in the Y-axis direction.

Infrared transmission units 1211 are provided at a lowest end part 1410 and an uppermost end part 1490 of a second frame 1500 corresponding to the first frame 1400 and arranged in a row in the Y-axis direction, and a plurality of infrared reception units 1215 are provided between the lowest end part 1410 and the uppermost end part 1490 in the Z-axis direction and arranged in a row in the Y-axis direction.

However, it is not always necessary to provide all the first frame 1200, second frame 1300, third frame 1400, and fourth frame 1500, but it is possible to provide only the first frame 1200 and the second frame 1300.

Accordingly, when the first frame 1200, second frame 1300, third frame 1400, and fourth frame 1500 are provided, the infrared transmission units 1211 arranged at the lowest end part 1210 and 1410 and the uppermost end part 1290 and 1490 irradiate touch measuring signals, and the corresponding infrared reception units 1215 detect the touch measuring signals, thus X-axis, Y-axis, and Z-axis coordinates of the touch object may be calculated.

First, as shown in FIG. 16, when the infrared transmission units 1211, which are arranged at the lowest end part 1210 of the first frame 1200, irradiate touch measuring signals, the facing infrared reception units 1215 of the second frame 1300 oblique-angle scan and detect the touch measuring signals in the Z-axis direction.

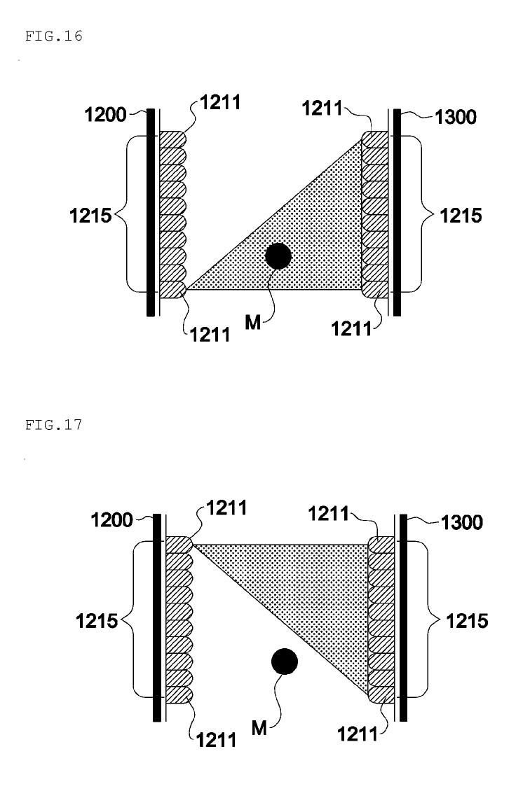

As shown in FIG. 17, when the infrared transmission units 1211, which are arranged at the uppermost end part 1290 of the first frame 1200, irradiate touch measuring signals, the facing infrared reception units 1215 of the second frame 1300 oblique-angle scan and detect the touch measuring signals in the Z-axis direction.

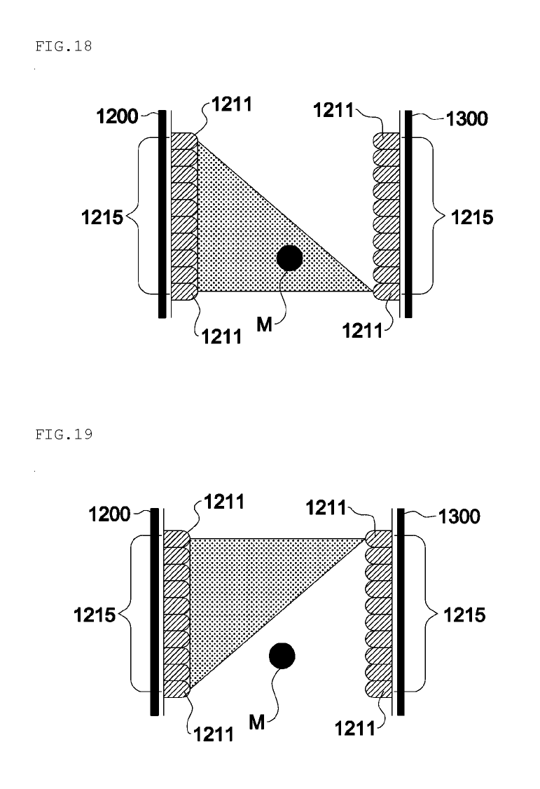

As shown in FIG. 18, when the infrared transmission units 1211, which are arranged at the lowest end part 1210 of the second frame 1300, irradiate touch measuring signals, the facing infrared reception units 1215 of the first frame 1200 oblique-angle scan and detect the touch measuring signals in the Z-axis direction.

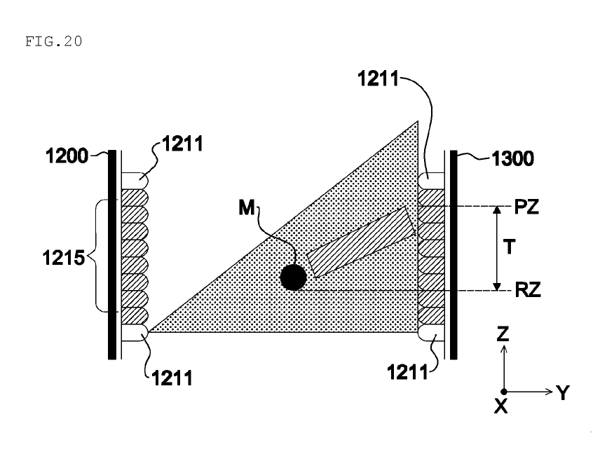

As shown in FIG. 19, when the infrared transmission units 1211, which are arranged at the uppermost end part 1290 of the second frame 1300, irradiate touch measuring signals, the facing infrared reception units 1215 of the first frame 1200 oblique-angle scan and detect the touch measuring signals in the Z-axis direction.

Although not shown, the third frame 1400 and the fourth frame 1500 may be operated as described in FIG. 16 to FIG. 19.

When the third frame 1400 and the fourth frame 1500 are provided in addition to the first frame 1200 and the second frame 1300, the more accurate touch position may be detected.

When the infrared transmission units 1211 of the first frame 1200 irradiate the touch measuring signals, the infrared reception units 1215 of the second frame 1300 scan downwardly or upwardly in the Z-axis direction, and the movement may be repeated while moving in the X-axis direction.

When the infrared transmission units 1211 of the second frame 1300 irradiate the touch measuring signals, the infrared reception units 1215 of the first frame 1200 scan downwardly or upwardly in the Z-axis direction, and the movement may be repeated while moving in the X-axis direction.

Operations between the third frame 1400 and the fourth frame 1500 proceed in the same manner as above, and scan operations may be repeated while moving in the Y-axis direction.

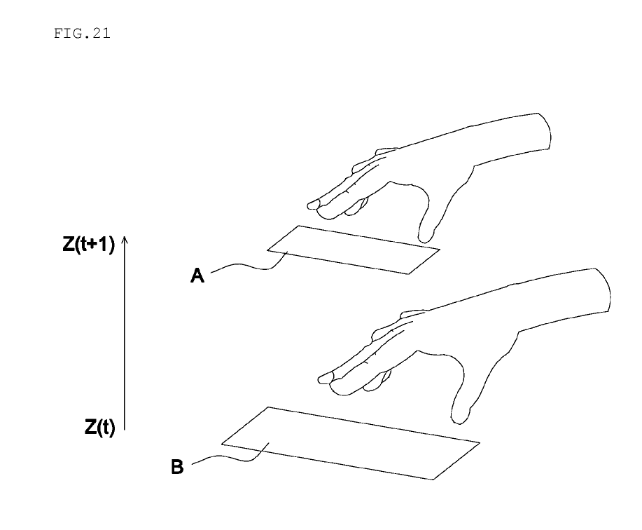

As mentioned above, when the touch object M is detected between the first frame 1200 and the second frame 1300 during the scanning, a position of the touch object M is detected at the height of PZ in the Z-axis direction of the second frame 1300, as shown in FIG. 20, which is higher than an actual height RZ by T.

A procedure to calibrate the position of the touch object M into an accurate position is required, because the position of the above touch object M is obtained by the oblique-angle scanning.

By using triangulation between the infrared transmission units 1211 and the facing infrared reception units 1215 for the position calibration, the height of the touch object M may be calibrated as the height RZ.

The height RZ becomes an actual Z-axis coordinate of the touch object M, and the position, which is in the X-axis direction of the infrared transmission units 1211 of the first frame 1200 or the infrared reception units 1215 of the second frame 1300 where the touch object M is detected, becomes an X-axis coordinate of the touch object M.

Likewise, when the touch object M is detected by proceeding the scanning with respect to the infrared transmission units 1211 and the facing infrared reception units 1215 at the third frame 1400 and the fourth frame 1500, respectively, in the Y-axis direction, the position, which is in the Y-axis direction of the infrared transmission units 1211 or the infrared reception units 1215, becomes a Y-axis coordinate of the touch object M.

Accordingly, X-axis, Y-axis and Z-axis coordinates of the touch object M are finally detected.

In addition, the Y-axis coordinate of the touch object M may be detected in advance by proceeding the scanning at the third frame 1400 and the fourth frame 1500, and then the X-axis coordinate of the touch object M may be detected by proceeding the scanning at the first frame 1200 and the second frame 1300.

As described in the first embodiment and the second embodiment, the touch screen apparatus and the display apparatus using the three-dimensional position information according to the present invention may detect a three-dimensional coordinates of a plurality of touch objects M as well as just one touch object M.

Accordingly, when the plurality of touch objects M move in the X-axis and/or Y-axis direction while moving along the Z-axis, changes of user actions may be detected through area changes of a region including the plurality of touch objects M.

FIG. 21 is a view for explaining detection of changes of user actions in accordance with the embodiment of the present invention.

Referring to FIG. 21, each end portion of user's fingers may be recognized as a touch object. For example, when an area of a region including the finger changes from a state of B at Z(t) into A after moving to Z(t+1), it may be determined that the user takes the finger folding action.

In this manner, it is available to determine user's various actions such as rotating fingers, or closing a hand and then open the hand.

Accordingly, a development of an interactive content through various three-dimensional image devices is available when the touch screen apparatus and the display apparatus using the three-dimensional position information according to the present invention are applied, utilized, or used. For example, the present invention may be applied to an advanced three-dimensional advertisement terminal apparatus, a tangible home appliance, a three-dimensional game entertainment, a kiosk, an online education, a tangible information search terminal, and so on.

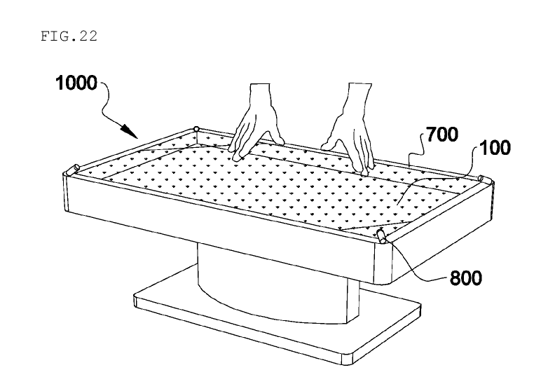

FIG. 22 is a view for explaining the touch screen apparatus and the display apparatus according to the second embodiment.

Referring to FIG. 22, similarly as described in FIG. 1, the display apparatus 1000 described in the second embodiment includes a touch screen apparatus 700, and the touch screen apparatus 700 may include the plurality of frames 1200, 1300, 1400, and 1500 aforementioned.

The image detection unit 800 may be installed at the plurality of frames 1200, 1300, 1400, and 1500.

The image detection unit 800 may be provided with a camera, thereby detecting changes of images obtained by the camera, and is arranged to be oriented to the slanting direction over the display unit 100.

Accordingly, a user action may be additionally detected through the image detecting unit 800 even when the user finger deviates from the space between the plurality of frames 1200, 1300, 1400, and 1500.

Preferable embodiments have been proposed and set forth in the aforementioned description, however the present invention should not be construed as limited thereto, and it will be apparent to any one of ordinary skill in the art in that many different substitutions, deformations and modifications are available within the scope without departing from the invention.

### INDUSTRIAL APPLICABILITY

The present invention may be applied to a touch screen apparatus and a display apparatus, and touch information may be detected in a three-dimensional space.

1. A touch screen apparatus using three-dimensional position information, the touch screen apparatus comprising:
a first frame having a plurality of optical transmission units arranged in a row along a first direction and stacked in a third direction orthogonal to the first direction;
a second frame facing the first frame and having a plurality of optical reception units arranged in a row along the first direction and stacked in the third direction; and
a control unit connected to the first frame and the second frame for controlling an operation of the plurality of optical transmission units and the plurality of optical reception units, and detecting a touch position in a three-dimensional space by using a signal detected at the plurality of optical reception units.

2. The touch screen apparatus of claim 1, wherein the first direction is an X-axis direction parallel to an X-Y plane parallel to a surface of a display unit, and
the third direction is a Z-axis direction orthogonal to the X-Y plane.

3. The touch screen apparatus of claim 1, wherein the first frame comprises a plurality of optical reception units, and the plurality of optical reception units are arranged in a row along the first direction and stacked in the third direction.

4. The touch screen apparatus of claim 1, wherein the second frame comprises a plurality of optical transmission units, and the plurality of optical transmission units are arranged along the first direction and stacked in the third direction.

5. The touch screen apparatus of claim 3, wherein at least one of a plurality of optical transmission units and a plurality of optical reception units included in the first frame is stacked on another one.

6. The touch screen apparatus of claim 4, wherein at least one of a plurality of optical transmission units and a plurality of optical reception units included in the second frame is stacked on another one.

7. The touch screen apparatus of claim 3, wherein a plurality of optical transmission units included in the first frame are arranged at a lowest end part and an uppermost end part of the first frame, and
a plurality of optical reception units included in the first frame are arranged between the lowest end part and the uppermost end part.

8. The touch screen apparatus of claim 4, wherein a plurality of optical transmission units included in the second frame are arranged at a lowest end part and an uppermost end part of the second frame, and
a plurality of optical reception units included in the second frame are arranged between the lowest end part and the uppermost end part.

9. The touch screen apparatus of claim 1, further comprising:
a third frame having a plurality of optical transmission units arranged in a row along a second direction orthogonal to the first direction and the third direction and stacked in the third direction; and
a fourth frame facing the third frame, having a plurality of optical reception units arranged in a row along the second direction and stacked in the third direction,
wherein the control unit is connected to the third frame and the fourth frame for controlling an operation of the plurality of optical transmission units and the plurality of optical reception units, and detecting a touch position in the three-dimensional space by using a signal detected at the plurality of optical reception units.

10. The touch screen apparatus of claim 9, wherein the first direction is an X-axis direction parallel to an X-Y plane parallel to a surface of a display unit,
the second direction is a Y-axis direction parallel to the X-Y plane parallel to the surface of the display unit, and
the third direction is a Z-axis direction orthogonal to the X-Y plane.

11. The touch screen apparatus of claim 9, wherein the third frame comprises a plurality of optical reception units, and
the plurality of optical reception units are arranged in a row along the second direction and stacked in the third direction.

12. The touch screen apparatus of claim 9, wherein the fourth frame comprises a plurality of optical transmission units, and the plurality of optical reception units are arranged along the second direction and stacked in the third direction.

13. The touch screen apparatus of claim 1, wherein the optical transmission unit is an infrared transmission unit, and the optical reception unit is an infrared reception unit.

14. The touch screen apparatus of claim 1, wherein the first frame and the second frame comprise an image detecting unit for photographing and detecting an image by a camera.

15. A display apparatus comprising:
a display unit for displaying an image; and
a touch screen apparatus using three-dimensional position information, in which the touch screen apparatus comprises:
a first frame arranged adjacent to the display unit and having a plurality of optical transmission units arranged in a row along a first direction and stacked in a third direction orthogonal to the first direction,
a second frame facing the first frame and having a plurality of optical reception units arranged in a row along the first direction and stacked in the third direction, and
a control unit connected to the first frame and the second frame for controlling an operation of the plurality of optical transmission units and the plurality of optical reception units and detecting a touch position in a three-dimensional space by using a signal detected at the plurality of optical reception units.
